(19) United States
(12) Patent Application Publication
(10) Pub. No.: US 2011/0197920 A1
(43) Pub. Date: Aug. 18, 2011

(54) Monitoring and Recording Device for Clean-In-Place System

(76) Inventors: Andy Kenowski, Waukesha, WI (US); Leo F. Bohanon, Oconomowoc, WI (US)

(21) Appl. No.: 12/706,509

(22) Filed: Feb. 16, 2010

(51) Int. Cl. B08B 7/04

(52) U.S. Cl. 134/10; 134/18

(57) ABSTRACT

A controller and recorder is disclosed for controlling, monitoring, and recording concentrations, temperature, air flow, fluid flow, and valve position a cleaning system. The invention allows a user to monitor multiple outputs at one time to quickly and efficiently diagnose malfunctions in the cleaning system. The invention records and archives the outputs during operation of the cleaning system. The data may then be downloaded by a user and analyzed for malfunctions in the system. For example, the data may indicate malfunctioning valves or fouled sensors in the cleaning system.

### CROSS-REFERENCE TO RELATED APPLICATION

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention relates to a device and methods for controlling, monitoring, and recording chemical concentrations, temperature, flow rate, air flow, and valve stem position in a clean-in-place system or similar automated washer.

2. Description of the Related Art

Food processing equipment, such as that found in dairies, tanks, pumps, valves and fluid piping, typically includes, tanks, pumps, valves, and fluid piping. This food processing equipment often needs to be cleaned between each lot of product processed through the equipment. However, the tanks, pumps, valves, and piping can be difficult to clean because the various components may be difficult to access and disassemble for cleaning. Because of these cleaning difficulties, many food processing plants now use clean-in-place systems in which the tanks, pumps, valves, and piping of the food processing equipment remain physically assembled, and various cleaning, disinfecting, and rinsing solutions are circulated by the clean-in-place system through the food processing equipment to effect the cleaning process.

An example clean-in-place cleaning cycle normally begins with a pre-rinse cycle wherein water is pumped through the food processing equipment for the purpose of removing loose soil in the system. Typically, an alkaline wash would then be recirculated through the food processing equipment. This alkaline wash would chemically react with the soils of the food processing equipment to further remove soil. A third step would again rinse the food processing equipment with water, prior to a fourth step wherein an acid rinse would be circulated through the batch processing system. The acid rinse would neutralize and remove residual alkaline cleaner and remove any mineral deposits left by the water. Finally, a post-rinse cycle would be performed, typically using water and/or a sanitizing rinse. Such clean-in-place systems (and associated cleaning compositions) are known in the art, and examples can be found in U.S. Pat. Nos. 6,423,675, 6,391,122, 6,161,558, 6,136,362, 6,089,242, 6,071,356, 5,888,311, 5,533,552, 5,427,126, 5,405,452, 5,348,058, 5,282,889, 5,064,561, 5,047,164, 4,836,420, and 2,897,829.

Devices for the automatic dispensing of cleaning, rinsing, and/or sanitizing chemicals to the chemical reservoirs of a clean-in-place system or similar automated washer are also known. For example, U.S. Pat. Nos. 5,681,4000, 5,556,478, and 5,404,893 describe a programmable detergent controller where a microprocessor compares a detergent concentration from a sensor in a wash tank. Based on this comparison, the microprocessor determines when a solenoid valve should be opened to allow the feeding of detergent solution into the wash tank.

U.S. Patent Application No. 2003/0127110 describes an automatic dispensing system for a washer. A probe sensor measures the electrical conductivity of water within the washer and produces a conductivity measurement. Because detergents are an alkali and or an acid, the water conductivity varies with the detergent concentration. Therefore, by sensing the water conductivity, a control system is able to determine how much detergent is needed to be added at the beginning of a wash cycle. The controller operates a detergent flow control device in a first mode in which the quantity of detergent dispensed into the washer is determined in response to the electrical conductivity of the water. If the conductivity measurement is determined to be unreliable, the controller operates in a second mode in which a predefined quantity of detergent is dispensed into the washer. In the second mode, software turns the detergent pump on for a fixed period of time required to dispense the predefined quantity of liquid detergent as specified by the software configuration parameters.

U.S. Pat. No. 5,500,050 describes a detergent dispenser controller for use with a washing deice that measures detergent concentration in a tank by measuring the conductivity of the detergent solution in the tank. Whenever the detergent dispenser is powered on, it determines the difference between the measured tank detergent concentration and a specified detergent concentration set point value. The computed difference between the set point and the current detergent concentration are used to compute the amount of time detergent should be dispensed to the tank. The detergent dispenser is then turned on for the computed time.

U.S. Pat. Nos. 5,494,061, and 5,453,131 describe a liquid chemical dispensing system for dispensing a plurality of liquid chemicals into a washer. The system includes at least a detergent pump and a rinse agent pump, and a data processor enables a user to set values for a rinse run time parameter, a detergent run time parameter, and a rinse delay time. The data processor stores those parameters in the non-volatile memory.

U.S. Pat. No. 4,756,321 describes a chemical dispenser and controller for industrial washers. The level of detergent concentration in the wash water is measured by a conductivity sensor. The controller also monitors the detergent concentration level and generates an alarm if the measured detergent concentration fails to increase by at least a predefined amount while the detergent feeding mechanism is turned on. Another feature of the controller is that it generates an alarm if the measured detergent concentration fails to reach its target level after the detergent feeding mechanism has been on for a predetermined time.

The known devices for the automatic dispensing of chemicals to the chemical reservoirs of a clean-in-place system may provide for more efficient use of cleaning chemicals. For instance, the overuse of a cleaning chemical can be avoided by measuring the concentration of a cleaning chemical in a wash tank and only adding enough cleaning chemical to keep the wash tank cleaning solution at a predetermined concentration. However, conductivity probes can be fouled over time by chemical build-up thereby providing false indications of the water conductivity. Also, conductivity probes can fail thereby providing no indication of the water conductivity. Systems with fouled or nonfunctioning probes lead to overuse of a cleaning chemical.

Devices for monitoring clean-in-place system wash conditions are also known. U.S. Pat. No. 6,089,242 describes a dairy pipeline washing system including sensors that monitor wash conditions. An example sensor is a wash water pH sensor. The system includes a data processor that receives signals from the sensors and compares predetermined wash parameters with the sensed wash conditions. The data processor allows a user to adjust parameters. Alarm signals are provided for out of range readings to allow for altering the chemical composition. The system also allows an operator to alter the amount of chemical to be dispensed. Also, in U.S. Patent Application No. 2002/0119574 and U.S. Pat. No. 6,323,033 there is described a clean-in-place system where multiple conductivity sensors are used to determine if a milk line is sufficiently cleaned with cleaning fluid.

The known devices for monitoring clean-in-place system wash conditions may provide for more efficient operation of a clean-in-place system. However, these devices may not be suitable for diagnosing all clean-in-place system fluid flow problems such as non-operational valves. Additionally, these devices are generally limited in the number and type of sensors that can be used in a single system.

There is still a need for a device and methods for controlling and recording multiple chemical concentrations, temperature, flow rate, air flow, and valve stem position in a clean-in-place system in order to avoid the overuse of cleaning chemicals, to ensure that all systems are properly cleaned, and to provide a tool for diagnosis of clean-in-place system flow problems.

U.S. Pat. Nos. 6,767,408 and 7,614,410 (which are incorporated herein by reference) are owned by the owner of the current invention. These patents set forth, among others, a method for cleaning an apparatus using a clean-in-place system and a chemical concentration controller and recorder for controlling and recording chemical concentrations in a cleaning system respectively.

In one example embodiment illustrated in U.S. Pat. No. 7,614,410, the invention allows a user to control the concentration of two or more chemicals in the cleaning system simultaneously using either concentration-based feed or timed-feed. The invention records and archives chemical concentration data from sensors in the cleaning system tanks or the cleaning system fluid conduits during operation of the cleaning system. The data may then be downloaded by a user and analyzed for efficiency and cost control purposes. For example, the data may indicate the overfeeding of chemicals to the cleaning system or leaking valves in the cleaning system.

In view of the advances in the art provided by the devices of U.S. Pat. Nos. 6,767,408 and 7,614,410, even further improvements to this technology would be beneficial to consumers.

### SUMMARY OF THE INVENTION

The present invention satisfies the foregoing needs by providing a controller and recorder for multiple chemical concentrations, temperature, flow rate, air flow, and valve stem position in a clean-in-place system. The invention allows a user to control the concentration of two or more chemicals simultaneously while monitoring proper valve operation via temperature, air flow, and valve position sensing. The invention records and archives concentration, temperature, flow rate, air flow, and valve stem position. The data may be downloaded by a user and analyzed for efficiency and cost control purposes. The data may also be used to ensure that valves are opening correctly and that sensors are not fouled or malfunctioning.

In one aspect the invention provides a cleaning system including a pump for supplying a cleaning chemical to a tank for holding a cleaning mixture of the cleaning chemical and a diluting fluid. The cleaning system also includes a fluid supply conduit in fluid communication with a cleaning location and the tank and a fluid return conduit in fluid communication with the cleaning location and the tank. The cleaning system further includes a drain in fluid communication with the cleaning location and a valve located in the fluid supply conduit. The valve has an open position and a closed position. The cleaning system also includes a valve position sensor associated with the valve. The valve position sensor outputs position signals indicative of whether the valve is in the open position or in the closed position.

In one form of the cleaning system, the valve position sensor outputs position signals indicative of whether the valve is fully open, fully closed, and in positions between the open position and the closed position. The cleaning system may also include a control system for the cleaning system, which in turn includes a controller having a processor and a data storage means. The processor is in electrical communication with the valve position sensor and the data storage means. The controller is configured to execute a stored program to: record in the data storage means a data table including (i) time intervals during a period of operation of the cleaning system, and (ii) valve position values associated with each of the time intervals. The valve position values are derived by the processor from valve position signals received from the valve position sensor.

In another form, the cleaning system may also include an air supply conduit in fluid communication with the valve and a source of air, where the air moves the valve between the open position and the closed position and an air flow sensor. The air flow sensor outputs air flow signals indicative of whether air flow is present or not. The processor is also in electrical communication with the air flow sensor and the controller is further configured to execute a stored program to: record in the data storage means a data table including air flow associated with each of the time intervals. The air flow values are derived by the processor from air flow signals received from the air flow sensor.

In yet another form, the controller executes the stored program to provide an alarm signal if the air flow sensor outputs a signal indicating air flow and the valve position sensor outputs a signal indicating that the valve is in the closed position. The controller can execute the stored program to download the data table via an interface to a computer or wirelessly transmit the data table to a computer.

In another form, the cleaning system includes a second cleaning location in fluid communication with the fluid supply conduit and the fluid return conduit; a second valve located in the fluid supply conduit between the tank and the second cleaning location; and a second valve position sensor associated with the second valve. The valve position sensor outputs position signals indicative of whether the valve is in the open position or in the closed position. The valve position sensor may be physically detached from the controller.

The cleaning system may also include a heat exchanger located in the fluid supply conduit between the tank and the valve and a temperature sensor located in the fluid supply conduit between the valve and the cleaning location. The temperature sensor outputs temperature signals indicative of a temperature of a component of fluid passing the sensor. The controller is further configured to execute a stored program to: record in the data storage means a data table including temperature values associated with each of the time intervals. The temperature values are derived by the processor from temperature signals received from the temperature sensor. The controller can execute the stored program to provide an alarm signal if the air flow sensor outputs a signal indicating air flow and (1) the valve position sensor outputs a signal indicating that the valve is in the closed position or (2) the temperature sensor outputs a signal indicating that the temperature of the component of fluid passing the sensor is less than a predetermined temperature. The controller may include a display for outputting position values of the valve.

The cleaning system may also include a second pump for supplying a second cleaning chemical to a second tank for holding a second cleaning mixture of the second cleaning chemical and a second diluting fluid. The second tank is in fluid communication with the fluid supply conduit and the fluid return conduit.

In another aspect the invention provides a cleaning system including a pump for supplying a cleaning chemical to a tank for holding a cleaning mixture of the cleaning chemical and a diluting fluid. The cleaning system may include a fluid supply conduit in fluid communication with a cleaning location and the tank and a fluid return conduit in fluid communication with the cleaning location. The cleaning system may also include a valve located in the fluid supply conduit, a heat exchanger located in the fluid supply conduit between the tank and the valve, and a temperature sensor located in the fluid supply conduit between the valve and the cleaning location. The temperature sensor outputs temperature signals indicative of a temperature of a component of fluid passing the sensor. The cleaning system also includes an air supply conduit in fluid communication with the valve and a source of air. The air moves the valve between the open position and the closed position. The cleaning system may further include an air flow sensor. The air flow sensor outputs air flow signals indicative of whether air flow is present or not.

In one form, the cleaning system may include a control system for the cleaning system. The control system includes a controller. The controller has a processor and a data storage means. The processor is in electrical communication with the air flow sensor, the temperature sensor; and the data storage means. The controller is configured to execute a stored program to record in the data storage means a data table including: (i) time intervals during a period of operation of the cleaning system; (ii) temperature values associated with each of the time intervals; (iii) air flow associated with each of the time intervals. The temperature values are derived by the processor from temperature signals received from the temperature sensor. The air flow values are derived by the processor from air flow signals received from the air flow sensor.

In another form, the controller executes the stored program to provide an alarm signal if the air flow sensor outputs a signal indicating air flow and the temperature sensor outputs a signal indicating that the temperature of the component of fluid passing the sensor is less than a predetermined temperature. The controller can also execute the stored program to download the data table via an interface to a computer or wirelessly transmit the data table to a computer.

In yet another aspect the invention provides a cleaning system including a pump for supplying a cleaning chemical to a tank for holding a cleaning mixture of the cleaning chemical and a diluting fluid. A tank inlet conduit is in fluid communication with the tank and a source of the cleaning chemical. A fluid supply conduit is in fluid communication with a cleaning location and the tank. A fluid return conduit is in fluid communication with the cleaning location and the tank. A drain is in fluid communication with the cleaning location. A flow meter is located in the tank inlet conduit. The flow meter outputs flow rate signals indicative of the flow rate of a component of fluid passing the sensor. A concentration sensor is located in the fluid supply conduit. The sensor outputs concentration signals indicative of a concentration of a component of fluid passing the sensor.

In one form, the cleaning system includes a control system for the cleaning system. The control system includes a controller. The controller has a processor and a data storage means. The processor is in electrical communication with the flow meter, the concentration sensor, and the data storage means. The controller is configured to execute a stored program to: record in the data storage means a data table including (i) time intervals during a period of operation of the cleaning system, (ii) flow rate values associated with each of the time intervals, and (iii) concentration values associated with each of the time intervals. The flow rate values are derived by the processor from flow rate signals received from the flow meter. The concentration values are derived by the processor from concentration signals received from the concentration sensor.

In another form the cleaning system includes a second pump for supplying a second cleaning chemical to a second tank for holding a second cleaning mixture of the second cleaning chemical and a second diluting fluid. The second tank is in fluid communication with the fluid supply conduit and the fluid return conduit. The cleaning system may also include a second pump for supplying a second cleaning chemical to the tank. The cleaning system may include a second pump for supplying a second cleaning chemical to the fluid supply conduit. The controller may execute the stored program to provide an alarm signal if the concentration sensor outputs a concentration signal indicating a concentration of a component that goes above or below a predetermined concentration value based on the flow rate signal received from the flow meter.

### DESCRIPTION OF THE DRAWINGS

FIG. 1 is a schematic of one version of a conventional clean-in-place system.

FIG. 2 is a schematic of a clean-in-place system including one embodiment of a controller and recorder in accordance with the invention.

### DESCRIPTION OF THE INVENTION

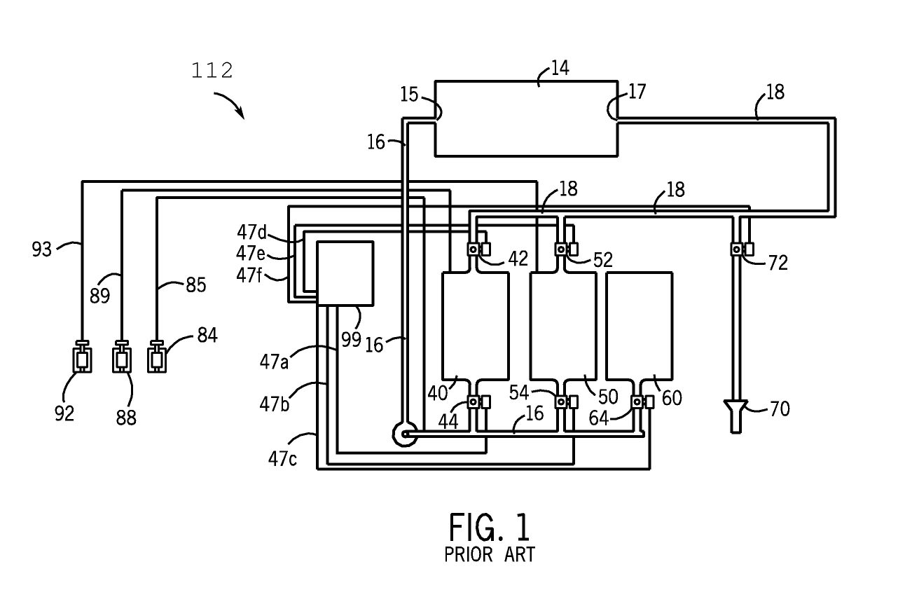

In order to provide background for the present invention, the arrangement and operation of one version of a conventional clean-in-place system will be described with reference to FIG. 1. The clean-in-place system, indicated generally at 112, is used to clean an apparatus, indicated generally at 14. The apparatus 14 may be, for example, food processing equipment, such as that found in dairies, breweries, and carbonated beverage plants, which typically includes tanks, pumps, valves, and fluid piping. The apparatus 14 to be cleaned by the clean-in-place system 112 is not limited to this type of equipment but may be any apparatus that can be cleaned by moving fluids through the apparatus.

The clean-in-place system 112 includes an alkaline tank 40, and acid tank 50, and a rinse tank 60. The alkaline tank 40 typically contains an alkaline cleaning solution used in the clean-in-place process, and suitable alkaline cleaning solutions are well known and commercially available. The acid tank 50 typically contains an acidic cleaning solution used in the clean-in-place process, and suitable acidic cleaning solutions are well known and commercially available. The rinse tank 60 contains a rinsing composition used in the clean-in-place process. In many clean-in-place systems the rinsing composition is water.

The alkaline tank 40, the acid tank 50, and the rinse tank 60 are placed in fluid communication in the clean-in-place system 112 and with the apparatus 14 by way of various conduits and valves. The clean-in-place system 112 includes a fluid supply conduit 16 that is connected to an inlet 15 of the apparatus 14. The fluid supply conduit 16 of the clean-in-place system 112 is also connected to the alkaline tank 40, the acid tank 50 and the rinse tank 60 through an alkaline supply valve 44, an acid supply valve 54, and a rinse supply valve 64, respectively. The fluid supply conduit 16 of the clean-in-place system 112 is also connected to a sanitizer pump 84 by way of a sanitizer conduit 85. The sanitizer pump 84 provides a sanitizing composition to the fluid supply conduit 16 as described below.

The clean-in-place system 112 also includes a fluid return conduit 18 that is connected to an outlet 17 of the apparatus 14. The fluid return conduit 18 of the clean-in-place system 112 is also connected to the alkaline tank 40 and the acid tank 50 through an alkaline return valve 42 and an acid return valve 52, respectively. The fluid return conduit 18 of the clean-in-place system 112 is also connected to a clean-in-place drain 70. A drain valve 72 is provided to control fluid flow from the fluid return conduit 18 of the clean-in-place system 112 to the drain 70.

The clean-in-place system 112 also includes an alkaline pump 88 that provides alkaline cleaning solution to the alkaline tank 40 by way of an alkaline conduit 89. An acid pump 92 is also provided to pump acidic cleaning solution to the acid tank 50 by way of an acid conduit 93. The valves of the clean-in-place system 112 are actuated using compressed air by way of control signals provided by lines 47a, 47b, 47c, 47d, 47e, and 47f to the valves from a programmable logic controller (PLC) 99. Such programmable logic controllers are commercially available from Rockwell Automation, Milwaukee, Wis.

Having described the construction of the clean-in-place system 112, the operation of the clean-in-place system 112 can now be described. After the apparatus 14 has completed one or more processes (such as a batch fluid packaging process), the clean-in-place system 112 is activated to clean and/or disinfect the apparatus 14. In a first step of the clean-in-place process, often termed the “first rinse” step, the rinse supply valve 64 is opened and the drain valve 72 is opened to allow rinse water (and often some suspended or dissolved solids) to be pushed from the apparatus 14 into the drain 70 by way of rinse water. In a next step called a “rinse push”, the alkaline supply valve 44 is opened, the alkaline return valve 42 remains closed, and the drain valve 72 remains open, thereby pushing further amounts of the rinse water into the drain 70 by way of the alkaline cleaning solution from the alkaline tank 40.

In a following “alkaline wash” step, the alkaline supply valve 44 remains open, the alkaline return valve 42 is opened, and the drain valve 72 is closed such that the alkaline cleaning solution is circulated and recirculated through the clean-in-place system 112 and the apparatus 14. Various compositions are suitable as the alkaline cleaning solution, and typically these alkaline solutions react with fatty acids in organic soils in the apparatus 14 to produce a salt by way of an acid-base reaction.

In a next step called “alkaline rinse push”, the rinse supply valve 64 is opened, the alkaline return valve 42 remains open, and the alkaline supply valve 44 is closed, thereby pushing the alkaline cleaning solution in the clean-in-place system 112 and the apparatus 14 into the alkaline tank 40. In a subsequent step called “alkaline rinse”, the rinse supply valve 64 remains open, and the drain valve 72 is opened, thereby sending rinse water (and suspended or dissolved solids) to the drain 70. In a following step called “rinse push”, the rinse supply valve 64 is closed, the acid supply valve 54 is opened, the acid return valve 52 remains closed and the drain valve 72 remains open, thereby pushing further rinse water (and suspended or dissolved solids) to drain 70.

In a following “acid wash” step, the acid supply valve 54 remains open, the acid return valve 52 is opened, and the drain valve 72 is closed such that acidic cleaning solution is circulated and recirculated through the clean-in-place system 112 and the apparatus 14. Various compositions are suitable as the acidic cleaning solution, and typically these acidic solutions react with basic materials (e.g. minerals) in the apparatus 14 to produce a salt by way of an acid-base reaction.

In a next step called “acid rinse push”, the rinse supply valve 64 is opened, the acid return valve 52 remains open, and the acid supply valve 54 is closed, thereby pushing the acidic cleaning solution in the clean-in-place system 112 and the apparatus 14 into the acid tank 50. In a following step called “acid rinse”, the rinse supply valve 64 remains open, the acid return valve 52 is closed, and the drain valve 72 is opened, thereby sending rinse water (and suspended or dissolved solids) to the drain 70.

In a following step called “sanitize”, the rinse supply valve 64 remains open, the drain valve 72 remains open, and the PLC 99 initiates delivery of sanitizer from the sanitizer pump 84 by way of the sanitizer conduit 85 to the fluid supply conduit 16. The rinse water including the injected sanitizer is circulated through the clean-in-place system 112 and the apparatus 14, and is sent to drain 70. In a next step called “sanitizer push”, sanitizer injection is stopped, the rinse supply valve 64 remains open and the drain valve 72 remains open thereby pushing the remaining sanitizer/water mixture to drain 70. The clean-in-place process is then complete.

It should be understood that the arrangement and operation of the clean-in-place system of FIG. 1 have been described for background context for the present invention. Numerous modifications of the clean-in-place system of FIG. 1 are possible. Several non-limiting examples of modifications of the clean-in-place system of FIG. 1 include (1) a clean-in-place system having either an alkaline tank 40 or an acid tank 50; and (2) the clean-in-place system of FIG. 1 wherein various fluid “pushing” processes (e.g. “alkaline rinse push” or “acid rinse push”) are executed by way of air from the air source rather than liquids from the alkaline tank 40, the acid tank 50, and/or the rinse tank 60.

Having described the construction and operation of the conventional clean-in-place system 112 shown in FIG. 1, some drawbacks and disadvantages of such a conventional clean-in-place system can be highlighted. Typically, devices are provided in such clean-in-place systems for the automatic dispensing of alkaline and acid chemicals to the alkaline tank and the acid tank of the clean-in-place system to provide for more efficient use of cleaning chemicals. For instance, the overuse of a cleaning chemical can be avoided by measuring the concentration of a cleaning chemical in the alkaline or acid tank with a conductivity probe and only adding enough cleaning chemical to keep the tank cleaning solutions at a predetermined concentration.

However, conductivity probes can be fouled over time by chemical build-up thereby providing false indications of the water conductivity. Also, conductivity probes can fail thereby providing no indication of the water conductivity. Systems with fouled or nonfunctioning probes lead to overuse of a cleaning chemical. Also, known devices for monitoring clean-in-place system wash conditions may provide for more efficient operation of a clean-in-place system. However, these devices may not be suitable for diagnosing clean-in-place system fluid flow problems such as leaking or malfunctioning valves.

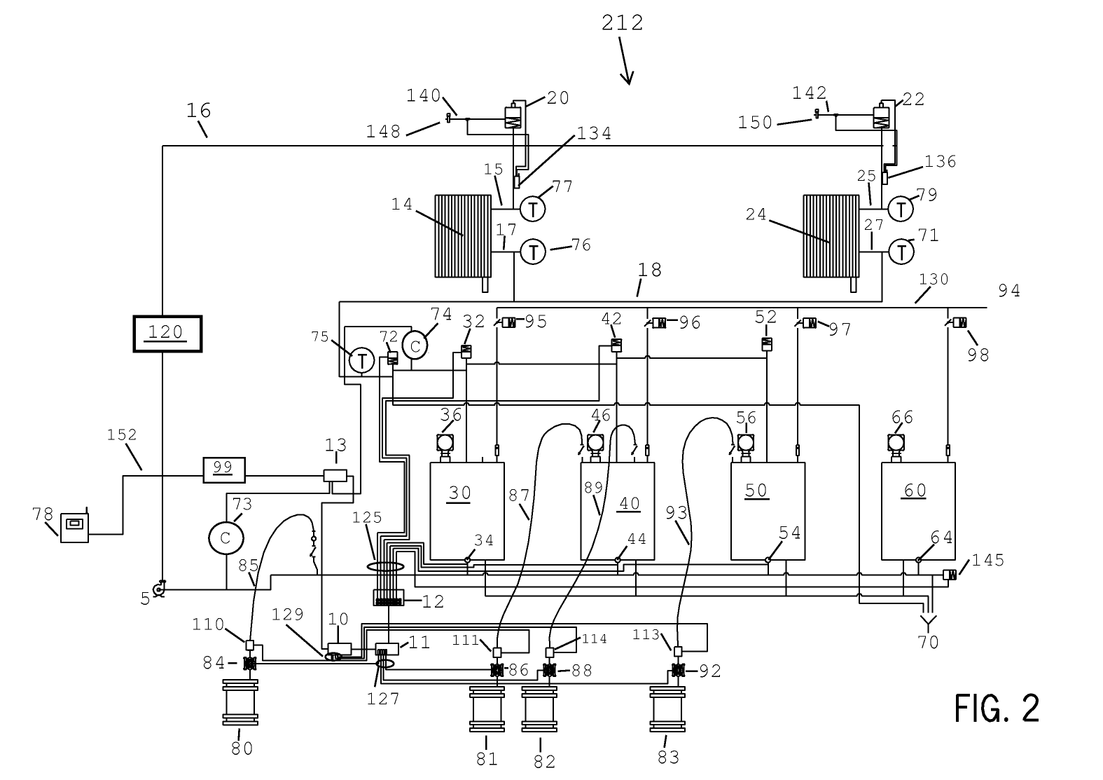

Referring now to FIG. 2, there is shown one solution to these problems. Specifically, a schematic of a clean-in-place system according to the invention, indicated generally at 212, is shown. The clean-in-place system 212 of FIG. 2 includes many of the components of the clean-in-place system of FIG. 1. The clean-in-place system 212 of FIG. 2 includes a pre-rinse tank 30, an alkaline tank 40, an acid tank 50, and a post rinse tank 60. The pre-rinse tank 30 contains a rinsing composition used in the clean-in-place process. In one embodiment the rinsing composition is water. The alkaline tank 40 typically contains an alkaline cleaning solution used in the clean-in-place process, and the acid tank 50 typically contains an acid cleaning solution used in the clean-in-place process. The post rinse tank 60 contains a rinsing composition used in the clean-in-place process. In one embodiment the rinsing composition is water. A pre-rinse tank conductivity sensor 36, an alkaline tank conductivity sensor 46, an acid tank conductivity sensor 56, and a post rinse tank conductivity sensor 66 are located in the pre-rinse tank 30, the alkaline tank 40, the acid tank 50, and the post rinse tank 60, respectively. The pre-rinse tank conductivity sensor 36, the alkaline tank conductivity sensor 46, the acid tank conductivity sensor 56, and the post rinse tank conductivity sensor 66 are in electrical communication with a controller 78 via a wireless link. The pre-rinse tank 30, the alkaline tank 40, the acid tank 50, and the post rinse tank 60 are placed in fluid communication with a source of water 94 by way of a water conduit 130 and pre-rinse water valve 95, alkaline water valve 96, acid water valve 97, and post rinse water valve 98, respectively. The pre-rinse tank 30, the alkaline tank 40, the acid tank 50, and the post rinse tank 60 are placed in fluid communication with the clean-in-place system 212 and with the apparatus 14 and the apparatus 24 by way of various conduits and valves.

The clean-in-place system 212 includes a fluid supply conduit 16 that is connected to the pre-rinse tank 30, the alkaline tank 40, the acid tank 50, and the post rinse tank 60 through a pre-rinse supply valve 34, an alkaline supply valve 44, an acid supply valve 54, and a post rinse supply valve 64, respectively. The fluid supply conduit 16 is connected to the inlet 15 of the apparatus 14 and the inlet 25 of the apparatus 24. A pump 5 and a heat exchanger 120 are provided in the fluid supply conduit 16 between the pre-rinse tank 30 and the inlet 15 of the apparatus 14. The pump 5 provides the cleaning solution to either the apparatus 14, the apparatus 24, or both. The heat exchanger 120 can be used to adjust the temperature of the cleaning solution before it enters the first apparatus 14 or the second apparatus 24. The fluid supply conduit 16 of the clean-in-place system 212 is also connected to a sanitizer pump 84 by way of a sanitizer conduit 85. The sanitizer pump 84 provides a sanitizing composition from a source of sanitizer 80 to the fluid supply conduit 16. A sanitizer flow meter 110 is located in the sanitizer conduit 85 to monitor the flow rate of the sanitizing composition into the clean-in-place system 212. Flow meters are well known and commercially available.

The clean-in-place system 212 includes a valve 20 located in the fluid supply conduit 16 between the heat exchanger 120 and the apparatus 14 which serves to direct the cleaning solution to either apparatus 14 or apparatus 24. The clean-in-place system 212 also includes a valve 22 located in the fluid supply conduit 16 between the apparatus 14 and the apparatus 24 to control the flow of cleaning solution to apparatus 24. Valve 20 and valve 22 are actuated using compressed air by way of control signals provided by line 140 and line 142, respectively, to the valves from the programmable logic controller 99 by means of a wireless link. Wireless radio frequency data communications are known in the art and systems are commercially available. While this described embodiment contemplates a radio frequency link between valve 20/valve 22 and the controller 78, other wireless links such as an LED, infrared or sound links and cabled links such as RS 232 or RS 485 may be used for this and all described wireless links and electrical communications. An air flow sensor 148 is provided in line 140 to sense air flow. An air flow sensor 150 is provided in line 142 to sense air flow. Air flow sensor 148 and air flow sensor 150 are in electrical communication with the controller 78 via a wireless link.

The clean-in-place system 212 also includes a fluid return conduit 18 that is connected to the outlet 27 of the second apparatus 24. The fluid return conduit 18 of the clean-in-place system 212 is also connected to the pre-rinse tank 30, the alkaline tank 40, and the acid tank 50 through a pre-rinse return valve 32, an alkaline return valve 42, and an acid return valve 52, respectively. The fluid return conduit 18 of the clean-in-place system 212 is also connected to a clean-in-place system drain 70. A drain valve 72 is provided to control fluid flow from the fluid return conduit 18 of the clean-in-place system 212 to the drain 70.

The clean-in-place system 212 also includes a first alkaline pump 86 that provides a first alkaline cleaning solution from a source of alkaline cleaning solution 81 to the alkaline tank 40 by way of a first alkaline conduit 87 and a second alkaline pump 88 that provides a second alkaline cleaning solution from a source of alkaline cleaning solution 82 to the alkaline tank 40 by way of a second alkaline conduit 89. A first alkaline flow meter 111 is located in the first alkaline conduit 87 to monitor the flow rate of the first alkaline cleaning solution into the clean-in-place system 212. A second alkaline flow meter 114 is located in the second alkaline conduit 89 to monitor the flow rate of the second alkaline cleaning solution into the clean-in-place system 212. An acid pump 92 is also provided to pump acid cleaning solution from a source of acid cleaning solution 83 to the acid tank 50 by way of an acid conduit 93. An acid flow meter 113 is located in the acid conduit 93 to monitor the flow rate of the acid cleaning solution into the clean-in-place system 212.

The pre-rinse supply valve 34, pre-rinse return valve 32, alkaline supply valve 44, alkaline return valve 42, acid supply valve 54, acid return valve 52, post rinse supply valve 64, and drain valve 72 are actuated using compressed air by way of control signals provided by lines 125 to the valves from a programmable logic controller 99 by means of an air input card 12. Fluid flow in the clean-in-place system 212 may be controlled by the programmable logic controller 99 using the “first rinse”, “rinse push”, “alkaline wash”, alkaline rinse push“, alkaline rinse”, “rinse push”, “acid wash”, “acid rinse push”, and “sanitize” operation steps described above with reference to FIG. 1.

The clean-in-place system 212 of FIG. 2 further includes a controller 78 that is interfaced with the programmable logic controller 99 via line 152. The programmable logic controller 99 includes a flow card 10, an air valve card 11, an air input card 12, and a conductivity card 13. The flow card 10, air valve card 11, air input card 12, and conductivity card 13 can each have multiple inputs, which creates a great deal of flexibility in the design of a clean-in-place system. The flow card 10 has electrical circuitry that is in electrical communication with the sanitizer flow meter 110, the first alkaline flow meter 111, the second alkaline flow meter 114, and the acid flow meter 113 via lines 129. The programmable logic controller 99 provides control signals through lines 127 by means of air valve card 11, which has electrical circuitry, to actuate the sanitizer pump 84, the first alkaline pump 86, the second alkaline pump 88, and the acid pump 92 using compressed air. As previously described, the pre-rinse supply valve 34, pre-rinse return valve 32, alkaline supply valve 44, alkaline return valve 42, acid supply valve 54, acid return valve 52, post rinse supply valve 64, and drain valve 72 are actuated using compressed air by way of control signals provided by lines 125 to the valves from the programmable logic controller 99 by means of the air input card 12, which has electrical circuitry.

A conductivity sensor 73 is provided in fluid supply conduit 16 between the pre-rinse tank 30 and the inlet 15 of the apparatus. The conductivity sensor 73 is in electrical communication with the controller 78 via the conductivity card 13, which has an electrical circuit. A conductivity sensor 74 is also provided in the fluid return conduit 18 between the outlet 27 of apparatus 24 and the pre-rinse return valve 32. The conductivity sensor 74 is in electrical communication with the controller 78 via the conductivity card 13. Conductivity sensors are well known and commercially available. Alternatively, the conductivity sensors could be replaced by pH sensors or any other sensors that can measure the concentration of a component in a fluid.

The clean-in-place system 212 also includes a temperature sensor 77 located in the inlet 15 to the apparatus 14. A temperature sensor 79 is provided in the inlet 25 to apparatus 24. A temperature sensor 76 is provided in the outlet 17 to apparatus 14. A temperature sensor 71 is provided in the outlet 27 to apparatus 24. A temperature sensor is also located in the fluid return conduit 18 between the apparatus 14 and the drain valve 72. The temperature sensor 77, temperature sensor 79, temperature sensor 76, temperature sensor 71, and temperature sensor 75 are in electrical communication with the controller 78 via a wireless link. Temperature sensors are well known and commercially available.

The clean-in-place system 212 further includes a valve position sensor 134 associated with valve 20. The valve position sensor 134 is in electrical communication with the controller 78 via a wireless link. A valve position sensor 136 is also associated with valve 22. The valve position sensor is in electrical communication with the controller 78 via a wireless link. Valve position sensors are commercially available. For example, a valve position sensor can sense the position of a valve stem in a valve, for example a poppet valve.

The controller 78 includes a processor running externally or internally stored software and conventional data storage means (e.g., disk or digital memory) for recording signals received by the processor from the pre-rinse tank conductivity sensor 36, alkaline tank conductivity sensor 46, acid tank conductivity sensor 56, post rinse tank conductivity sensor 66, conductivity sensor 73, and conductivity sensor 74 as a function of time. The controller 78 also records signals received by the processor from the temperature sensor 77, temperature sensor 75, temperature sensor 76, temperature sensor 71, and temperature sensor 79 as a function of time. Further, the controller 78 records signals received by the processor from the valve position sensor 134, valve position sensor 136, sanitizer flow meter 110, first alkaline flow meter 111, second alkaline flow meter 114, acid flow meter 113, air flow sensor 148, and air flow sensor 150 as a function of time. The stored data may be viewed or printed out using well known data processing techniques. The data may be downloaded from the data storage means of the controller 78 to a computer (not shown) via a communication line (not shown). Alternatively, data may be downloaded from the data storage means of the controller 78 via infrared transmission to other mobile computer technology such as a commercially available wireless palm computer, i.e., a Personal Digital Assistant (PDA).

Without intending to limit the invention, one embodiment of a chemical concentration controller and recorder in accordance with the invention has the following specifications: Electrical Requirements—120V AC; Controller Options—up to four clean-in-place systems, up to sixteen conductivity probes, up to sixteen air flow sensors, four flow meters, multiple valve position sensors, and four temperature sensors; System Programming—Via laptop and RS 485 or RS 282 serial connection and RF wireless connection; and Data Downloading—Via infrared transmission to palm computer.

Having described the construction of the clean-in-place system 212 of FIG. 2, the operation of the clean-in-place system 212 can now be described. After the apparatus 14 and/or apparatus 24 has completed one or more processes (such as a batch fluid packaging process), the clean-in-place system 212 is activated to clean and/or disinfect either apparatus 14, apparatus 24, or both. Fluid flow in the clean-in-place system 212 may be controlled by the programmable logic controller 99 using the “first rinse”, “rinse push”, alkaline wash“, “alkaline rinse push”, “alkaline rinse”, “rinse push”, “acid wash”, “acid rinse push”, and “sanitize” operation steps described above with reference to FIG. 1.

During one embodiment of the clean-in-place process, the controller 78 records valve position signals received from valve position sensor 134 and valve position sensor 136 as a function of time and records air flow signals from air flow sensor 148 and air flow sensor 150 as a function of time. Monitoring both the position of valve 20 and valve 22 and the air flow in lines 140 and 142 provides a validation step to ensure that the clean-in-place system 212 is working properly. In order to begin the clean-in-place process, an operator manually enters the desired cleaning location into the controller 78. When apparatus 14 is cleaned and/or disinfected, air flows through line 140, which activates valve 20 and directs the cleaning fluid into apparatus 14. Valve position sensor 134 senses the position of valve 20, which verifies that valve 20 opens when directed. When apparatus 24 is cleaned and/or disinfected, air flows through line 142, which activates valve 22 and directs cleaning fluid into apparatus 24. Valve position sensor 136 senses the position of valve 22, which verifies that valve 22 opens when directed.

During a second embodiment of the clean-in-place process, the controller 78 records temperature signals received from temperature sensor 77 and temperature sensor 79 as a function of time and records air flow signals from air flow sensor 148 and air flow sensor 150 as a function of time. Monitoring both the temperature of a component of cleaning solution at temperature sensor 77 and temperature sensor 79 and the air flow in lines 140 and 142 provides a validation step to ensure that the clean-in-place system 212 is working properly. In order to begin the clean-in-place process, an operator manually enters the desired cleaning location into the controller 78. When apparatus 14 is cleaned and/or disinfected, air flows through line 140, which activates valve 20 and directs the cleaning fluid into apparatus 14. The cleaning solution is heated when it passes through heat exchanger 120. An increase in the temperature signal of temperature sensor 77 verifies that valve 20 opens when directed. When apparatus 24 is cleaned and/or disinfected, air flows through line 142, which activates valve 22 and directs cleaning fluid into apparatus 24. An increase in the temperature signal of temperature sensor 79 verifies that valve 22 opens when directed.

During a third embodiment of the clean-in-place process, the controller 78 records conductivity signals from conductivity sensor 46, conductivity sensor 56, and conductivity sensor 73 as well as flow rate signals from flow meter 110, flow meter 111, flow meter 114, and flow meter 113 as a function of time. When flow meter 111 or 114 outputs signals indicating fluid flow, conductivity sensor 46 should register an increase in pH in alkaline tank 40. When flow meter 113 outputs signals indicating fluid flow, conductivity sensor 50 should register a decrease in pH in acid tank 50. This provides a validation that the pumps are working properly and the conductivity sensors are not fouled or malfunctioning.

After one or more cleaning cycles of the clean-in-place process, the data stored in the controller 78 may be downloaded to a lap top computer or to a wireless PDA and printed and analyzed. The data may be analyzed by the user or by software in the computer or controller. The data provides as a function of time: (1) the measured air flow in line 140 as measured when air passes the air flow sensor 148; (2) the measured air flow in line 142 as measured when air passes the air flow sensor 150; (3) the measured position of valve 20 as measured by valve position sensor 134; and (4) the measured position of valve 22 as measured by valve position sensor 136. An example prophetic data table is shown as Table 1. Table 1 is presented for the purpose of illustration only and does not limit the invention in any way.

During the clean-in-place process, the chemical controller 78 can record signals received from the valve position sensor 134, the valve position sensor 136, the air flow sensor 148, the air flow sensor 150, the temperature sensor 76, the temperature sensor 77, the temperature sensor 71, the temperature sensor 79, the conductivity sensor 73, the conductivity sensor 36, the conductivity sensor 46, the conductivity sensor 56, the conductivity sensor 74, the flow meter 110, the flow meter 111, the flow meter 114, and the flow meter 113, as a function of time. After one or more cleaning cycles of the clean-in-place process, the data stored in the chemical controller 78 may be downloaded to a lap top computer or to a wireless PDA and printed and analyzed. The data may be analyzed by the user or by software in the computer or controller. The data provides as a function of time: (1) the position of each valve as measured by the valve position sensor 134, 136; (2) sensed air flow for each air flow sensor 148, 150; (3) measured temperature for the fluid as measured when the fluid passes each temperature sensor 76, 77, 71, 79; (4) the measured conductivity (which the processor can convert to pH readings) for the fluid as measured when the fluid passes each conductivity sensor 73, 36, 46, 56, 74; and (5) the measured flow rate for the fluid as measured when the fluid passes each flow meter 110, 111, 114, 113. A possible data table is shown as Table 1, which is presented for the purpose of illustration only and does not limit the invention in any way.

TABLE 1

| | | | | | | | | | C.S. | C.S. | C.S. | C.S. | C.S. | | | | |
|---|---|---|---|---|---|---|---|---|---|---|---|---|---|---|---|---|---|
| | V.S. | V.S. | Air | Air | T | T | T | T | # 1 | # 2 | # 3 | # 4 | # 5 | F.M. | F.M. | F.M. | F.M. |
| | # 1 | # 2 | #1 | #2 | #1 | #2 | #3 | #4 | (pH) | (pH) | (pH) | (pH) | (pH) | # 1 | # 2 | # 3 | # 4 |
| Time | 134 | 136 | 148 | 150 | 77 | 76 | 79 | 71 | 73 | 74 | 36 | 46 | 56 | 110 | 111 | 114 | 113 |
| 1:00:00 | Open | Closed | On | Off | 99 | 99 | 70 | 70 | 9 | 9 | 7 | 11 | 5 | 0 | 150 | 0 | 0 |
| 1:00:10 | Open | Closed | On | Off | 99 | 99 | 70 | 70 | 9 | 9 | 7 | 11 | 5 | 0 | 150 | 0 | 0 |
| 1:00:20 | Open | Closed | On | Off | 99 | 99 | 70 | 70 | 9 | 9 | 7 | 11 | 5 | 0 | 150 | 0 | 0 |
| 1:00:30 | Open | Closed | On | Off | 99 | 99 | 70 | 70 | 9 | 9 | 7 | 11 | 5 | 0 | 150 | 0 | 0 |
| 1:00:40 | Open | Closed | On | Off | 99 | 99 | 70 | 70 | 9 | 9 | 7 | 11 | 5 | 0 | 150 | 0 | 0 |
| 1:00:50 | Open | Closed | On | Off | 99 | 99 | 70 | 70 | 9 | 9 | 7 | 11 | 5 | 0 | 150 | 0 | 0 |
| 1:01:00 | Open | Closed | On | Off | 99 | 99 | 70 | 70 | 9 | 9 | 7 | 11 | 5 | 0 | 150 | 0 | 0 |
| 1:01:10 | Open | Closed | On | Off | 99 | 99 | 70 | 70 | 9 | 9 | 7 | 11 | 5 | 0 | 0 | 0 | 0 |
| 1:01:20 | Open | Closed | On | Off | 99 | 99 | 70 | 70 | 9 | 9 | 7 | 11 | 5 | 0 | 0 | 0 | 0 |
| 1:01:30 | Open | Closed | On | Off | 99 | 99 | 70 | 70 | 9 | 9 | 7 | 11 | 5 | 0 | 0 | 0 | 0 |
| 1:01:40 | Open | Closed | On | Off | 99 | 99 | 70 | 70 | 9 | 9 | 7 | 11 | 5 | 0 | 0 | 0 | 0 |
| 1:01:50 | Open | Closed | On | Off | 99 | 99 | 70 | 70 | 9 | 9 | 7 | 11 | 5 | 0 | 0 | 0 | 0 |
| 1:02:00 | Closed | Closed | Off | Off | 70 | 70 | 70 | 70 | 7 | 7 | 7 | 11 | 5 | 175 | 0 | 0 | 0 |
| 1:02:10 | Closed | Closed | Off | Off | 70 | 70 | 70 | 70 | 7 | 7 | 7 | 11 | 5 | 175 | 0 | 0 | 0 |
| 1:02:20 | Closed | Closed | Off | Off | 70 | 70 | 70 | 70 | 7 | 7 | 7 | 11 | 5 | 175 | 0 | 0 | 0 |
| 1:02:30 | Closed | Closed | Off | Off | 70 | 70 | 70 | 70 | 7 | 7 | 7 | 11 | 5 | 175 | 0 | 0 | 0 |
| 1:02:40 | Closed | Closed | Off | Off | 70 | 70 | 70 | 70 | 7 | 7 | 7 | 11 | 5 | 175 | 0 | 0 | 0 |
| 1:02:50 | Closed | Closed | Off | Off | 70 | 70 | 70 | 70 | 7 | 7 | 7 | 11 | 5 | 175 | 0 | 0 | 0 |
| 1:03:00 | Closed | Open | Off | On | 70 | 70 | 99 | 99 | 5 | 5 | 7 | 11 | 5 | 0 | 0 | 0 | 125 |
| 1:03:10 | Closed | Open | Off | On | 70 | 70 | 99 | 99 | 5 | 5 | 7 | 11 | 5 | 0 | 0 | 0 | 125 |
| 1:03:20 | Closed | Open | Off | On | 70 | 70 | 99 | 99 | 5 | 5 | 7 | 11 | 6 | 0 | 0 | 0 | 125 |
| 1:03:30 | Closed | Open | Off | On | 70 | 70 | 99 | 99 | 5 | 5 | 7 | 11 | 6 | 0 | 0 | 0 | 125 |
| 1:03:40 | Closed | Open | Off | On | 70 | 70 | 99 | 99 | 5 | 5 | 7 | 11 | 6 | 0 | 0 | 0 | 125 |
| 1:03:50 | Closed | Open | Off | On | 70 | 70 | 99 | 99 | 5 | 5 | 7 | 11 | 6 | 0 | 0 | 0 | 125 |

V.S. = Valve Position Sensor;
Air = Air Flow Sensor;
T = Temperature Sensor;
C.S. = Conductivity Sensor;
F.M. = Flow Meter

The data in the data table can identify certain malfunctions in the clean-in-place system 212 to help keep the clean-in-place system 212 functioning properly. The controller 78 executes a stored program to provide an alarm signal if the air flow sensor 148 outputs a signal indicating air flow and the valve position sensor 134 outputs a signal indicating that the valve 20 is in the closed position or has not reached the fully open position. The controller 78 also executes a stored program to provide an alarm signal if the air flow sensor 150 outputs a signal indicating air flow and the valve position sensor 136 outputs a signal indicating that the valve 22 is in the closed position or has not reached the fully open position. This provides a verification that valve 20 and valve 22 are working properly and opening as directed.

The controller 78 also executes a stored program to provide an alarm signal if the air flow sensor 148 outputs a signal indicating air flow and the temperature sensor 77 outputs a signal indicating that the temperature of the component of fluid passing the temperature sensor 77 is less than a predetermined temperature. The controller 78 also executes a stored program to provide an alarm signal if the air flow sensor 150 outputs a signal indicating air flow and the temperature sensor 79 outputs a signal indicating that the temperature of the component of fluid passing the temperature sensor 79 is less than a predetermined temperature.

The controller 78 further executes a stored program to provide an alarm signal if the conductivity sensor 46 outputs a concentration signal indicating a concentration of a component that goes above or below a predetermined concentration based on the flow rate signal received from either flow meter 111 or flow meter 114. The controller 78 also executes a stored program to provide an alarm signal if the conductivity sensor 56 outputs a concentration signal indicating a concentration of a component that goes above or below a predetermined concentration based on the flow rate received from flow meter 113.

The presence of an alarm in any of these circumstances indicates a malfunction in the clean-in-place system 212. Air flow past air flow sensor 148 should actuate valve 20. Valve position sensor 134 monitors the position of valve 20 to ensure that it opens completely. Air flow past air flow sensor 150 actuates valve 22. Valve position sensor 136 monitors the position of valve 22 to ensure that it opens completely. The presence of temperature sensor 77 and temperature sensor 71 provides a similar validation. Air flow past air flow sensor 148 actuates valve 20. Heat exchanger 120 heats the cleaning solution to a predetermined temperature. When valve 20 opens completely, the temperature output of temperature sensor 77 should rise to that predetermined temperature. Air flow past air flow sensor 150 actuates valve 22. Heat exchanger 120 heats the cleaning solution to a predetermined temperature. When valve 22 opens completely, the temperature output of temperature sensor 79 should rise to that predetermined temperature. Alarms involving valve position sensor 134 or temperature sensor 77 can indicate that valve 20 is not functioning properly and apparatus 14 may not receive the full benefit of the clean-in-place process. Alarms involving valve position sensor 136 or temperature sensor 79 can indicate that valve 22 is not functioning properly and apparatus 24 may not receive the full benefit of the clean-in-place process.

Similarly, fluid flow past flow meter 111 or 114 should result in an increase in the sensed pH in the alkaline tank 40. Fluid flow past flow meter 113 should result in a decrease in the sensed pH in the acid tank 50. The absence of the respective pH increase or decrease can provide an indication that various conduits or valves are leaking or that conductivity sensor 46 or conductivity sensor 56 is fouled or not providing feedback to the controller 78.

Thus, there has been provided a device and methods for controlling, monitoring, and recording chemical concentrations, temperature, flow rate, air flow, and valve stem position in a clean-in-place system or similar automated washer. While the invention has been described in the context of a clean-in-place system, it may be applied in other cleaning systems such as warewashers, central foam systems, tunnel washers, COP tanks, egg washers, membrane cleaning systems, form washers, case washers, and the like.

The clean-in-place controller and recorder has many features including, without limitation: (i) the controller and recorder monitors proper valve function; (ii) the controller and recorder monitors temperature of the clean-in-place system; (iii) the controller and recorder monitors the valve position of critical valves; (iv) the controller and recorder monitors the chemical concentration of various cleaning solutions in the clean-in-place system; (v) the controller and recorder monitors the flow rate of cleaning solutions into the clean-in-place system; (vi) the alarm settings provide notification when a malfunction occurs in the system; (vii) the controller and recorder uses personal computer or infrared download of data such that data can be downloaded to a personal computer or Palm held PDA for data analysis; (viii) the controller and recorder uses a 110 volt NEMA 4 cabinet that can be just plugged into an electrical outlet and that is water resistant.

Although the present invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein. For example, the features of the various embodiments can be used in combinations not herein described.

We claim:

1. A cleaning system comprising:
a pump for supplying a cleaning chemical to a tank for holding a cleaning mixture of the cleaning chemical and a diluting fluid;
a fluid supply conduit in fluid communication with a cleaning location and the tank;
a fluid return conduit in fluid communication with the cleaning location and the tank;
a drain in fluid communication with the cleaning location;
a valve located in the fluid supply conduit, the valve having an open position and a closed position; and
a valve position sensor associated with the valve, the valve position sensor outputting position signals indicative of whether the valve is in the open position or in the closed position.

2. The cleaning system of claim 1 wherein:
the valve position sensor outputs position signals indicative of whether the valve is fully open, fully closed, and in positions between the open position and the closed position.

3. The cleaning system of claim 1 further comprising a control system for the cleaning system, the control system comprising:
a controller having a processor and a data storage means, the processor being in electrical communication with the valve position sensor and the data storage means,
wherein the controller is configured to execute a stored program to:
record in the data storage means a data table including
(i) time intervals during a period of operation of the cleaning system, and
(ii) valve position values associated with each of the time intervals, the valve position values being derived by the processor from valve position signals received from the valve position sensor.

4. The cleaning system of claim 3 further comprising:
an air supply conduit in fluid communication with the valve and a source of air, the air moving the valve between the open position and the closed position; and
an air flow sensor;
wherein the air flow sensor outputs air flow signals indicative of whether air flow is present or not;
wherein the processor is also in electrical communication with the air flow sensor;
wherein the controller is further configured to execute a stored program to:
record in the data storage means a data table including
(iii) air flow associated with each of the time intervals, the air flow values being derived by the processor from air flow signals received from the air flow sensor.

5. The cleaning system of claim 4 wherein:
the controller executes the stored program to provide an alarm signal if the air flow sensor outputs a signal indicating air flow and the valve position sensor outputs a signal indicating that the valve is in the closed position.

6. The cleaning system of claim 4 wherein:
the controller executes the stored program to download the data table via an interface to a computer or wirelessly transmit the data table to a computer.

7. The cleaning system of claim 1 further comprising:
a second cleaning location in fluid communication with the fluid supply conduit and the fluid return conduit;
a second valve located in the fluid supply conduit between the tank and the second cleaning location; and
a second valve position sensor associated with the second valve, the valve position sensor outputting position signals indicative of whether the valve is in the open position or in the closed position.

8. The cleaning system of claim 3 wherein:
the valve position sensor is physically detached from the controller.

9. The cleaning system of claim 4 further comprising:
a heat exchanger located in the fluid supply conduit between the tank and the valve;
a temperature sensor located in the fluid supply conduit between the valve and the cleaning location, the temperature sensor outputting temperature signals indicative of a temperature of a component of fluid passing the sensor;
wherein the controller is further configured to execute a stored program to:
record in the data storage means a data table including
(iv) temperature values associated with each of the time intervals, the temperature values being derived by the processor from temperature signals received from the temperature sensor.

10. The cleaning system of claim 9 wherein:
the controller executes the stored program to provide an alarm signal if the air flow sensor outputs a signal indicating air flow and (1) the valve position sensor outputs a signal indicating that the valve is in the closed position or (2) the temperature sensor outputs a signal indicating that the temperature of the component of fluid passing the sensor is less than a predetermined temperature.

11. The cleaning system of claim 3 wherein:
the controller further includes a display for outputting position values of the valve.

12. The cleaning system of claim 1 wherein:
the cleaning system further comprises a second pump for supplying a second cleaning chemical to a second tank for holding a second cleaning mixture of the second cleaning chemical and a second diluting fluid, the second tank being in fluid communication with the fluid supply conduit and the fluid return conduit.

13. A cleaning system comprising:
a pump for supplying a cleaning chemical to a tank for holding a cleaning mixture of the cleaning chemical and a diluting fluid;
a fluid supply conduit in fluid communication with a cleaning location and the tank;
a fluid return conduit in fluid communication with the cleaning location;
a valve located in the fluid supply conduit;
a heat exchanger located in the fluid supply conduit between the tank and the valve;
a temperature sensor located in the fluid supply conduit between the valve and the cleaning location, the temperature sensor outputting temperature signals indicative of a temperature of a component of fluid passing the sensor;
an air supply conduit in fluid communication with the valve and a source of air, the air moving the valve between the open position and the closed position; and
an air flow sensor,
wherein the air flow sensor outputs air flow signals indicative of whether air flow is present or not.

14. The cleaning system of claim 13 further comprising a control system for the cleaning system, the control system comprising:
a controller having a processor and a data storage means, the processor being in electrical communication with the air flow sensor, the temperature sensor; and the data storage means,
wherein the controller is configured to execute a stored program to:
record in the data storage means a data table including:
(i) time intervals during a period of operation of the cleaning system
(ii) temperature values associated with each of the time intervals, the temperature values being derived by the processor from temperature signals received from the temperature sensor
(iii) air flow associated with each of the time intervals, the air flow values being derived by the processor from air flow signals received from the air flow sensor.

15. The cleaning system of claim 14 wherein:
the controller executes the stored program to provide an alarm signal if the air flow sensor outputs a signal indicating air flow and the temperature sensor outputs a signal indicating that the temperature of the component of fluid passing the sensor is less than a predetermined temperature.

16. The cleaning system of claim 14 wherein:
the controller executes the stored program to download the data table via an interface to a computer or wirelessly transmit the data table to a computer.

17. A cleaning system comprising:
a pump for supplying a cleaning chemical to a tank for holding a cleaning mixture of the cleaning chemical and a diluting fluid;
a tank inlet conduit in fluid communication with the tank and a source of the cleaning chemical;
a fluid supply conduit in fluid communication with a cleaning location and the tank;
a fluid return conduit in fluid communication with the cleaning location and the tank;
a drain in fluid communication with the cleaning location;
a flow meter located in the tank inlet conduit, the flow meter outputting flow rate signals indicative of the flow rate of a component of fluid passing the sensor; and
a concentration sensor located in the fluid supply conduit, the sensor outputting concentration signals indicative of a concentration of a component of fluid passing the sensor.

18. The cleaning system of claim 17 further comprising a control system for the cleaning system, the control system comprising:
a controller having a processor and a data storage means, the processor being in electrical communication with the flow meter, the concentration sensor, and the data storage means,
wherein the controller is configured to execute a stored program to:
record in the data storage means a data table including
(i) time intervals during a period of operation of the cleaning system,
(ii) flow rate values associated with each of the time intervals, the flow rate values being derived by the processor from flow rate signals received from the flow meter, and
(iii) concentration values associated with each of the time intervals, the concentration values being derived by the processor from concentration signals received from the concentration sensor.

19. The cleaning system of claim 18 further comprising a second pump for supplying a second cleaning chemical to a second tank for holding a second cleaning mixture of the second cleaning chemical and a second diluting fluid, the second tank being in fluid communication with the fluid supply conduit and the fluid return conduit.

20. The cleaning system of claim 18 further comprising a second pump for supplying a second cleaning chemical to the tank.

21. The cleaning system of claim 18 further comprising a second pump for supplying a second cleaning chemical to the fluid supply conduit.

22. The cleaning system of claim 18 wherein:
the controller executes the stored program to provide an alarm signal if the concentration sensor outputs a concentration signal indicating a concentration of a component that goes above or below a predetermined concentration value based on the flow rate signal received from the flow meter.
